(19) United States
(12) Patent Application Publication
(10) Pub. No.: US 2008/0129712 A1
(43) Pub. Date: Jun. 5, 2008

(54) Pen-based computer system having variable automatic scroll

(76) Inventor: Mitchell Van Nguyen, Westminster, CA (US)

Correspondence Address: ROY A. EKSTRAND, 3158 REDHILL AVE., STE 150, COSTA MESA, CA, 92626, US

(21) Appl. No.: 11/888,536

(22) Filed: Jul. 31, 2007

Related U.S. Application Data
(60) Provisional application No. 60/834,596, filed on Jul. 31, 2006.

(51) Int. Cl. G06F 3/033

(52) U.S. Cl. 345/179

(57) ABSTRACT

An auto-scrolling system suitable for use in a pen-based computing system is operative upon the display during text writing or other marking to exercise an intelligent variable auto scroll action when the right hand limit of the display is reached. The extent of scroll is determined by the left-most or pen-down action thereby allowing the user to complete incomplete letters.

### CROSS-REFERENCE TO RELATED PATENT APPLICATION

This application claims the benefit of and priority under 35 U.S.C. 119(e) of Provisional Patent Application No. 60/834,596 entitled PEN-BASED COMPUTER SYSTEM HAVING VARIABLE AUTOMATIC SCROLL filed Jul. 31, 2006 in the name of Mitchell Van Nguyen, the disclosure of which is hereby incorporated by reference.

### FIELD OF THE INVENTION

This invention relates generally to pen-based computer systems such as personal digital assistants, (PDAs), palm PCs, or pen tablets (collectively hereinafter referred to as “pen-based” handheld computers or pen-based computers) and particularly to the use thereof in functions such as writing, drawing or editing.

### BACKGROUND OF THE INVENTION

Pen-based computer systems are well known and extremely popular in the art. The term “pen-based” is derived primarily from the extensive use of a stylus or “pen” to input information or manipulate the operation of a computer using touch screen selection and input. The stylus or pen is not generally a writing instrument but rather an elongated somewhat pointed object which is often housed within the computer unit itself and withdrawn for its interaction and use. Typically, the pen may be used to touch the display screen in order to perform functions of interactions such as selection of a displayed icon, movement of a scroll icon for image displacement or writing and mark up upon a displayed image.

While virtually any computer utilizing a touch screen and interacting stylus for input function may, in a sense, be described as “pen-based”, the term has generally become descriptive in the computer arts of a handheld relatively small computer device which initially was referred to as a personal digital assistant (PDA). A substantial variety of such pen-based computers have been provided in the art by manufacturers such as Palm, Sony, Handspring, ViewSonic, Hewlett-Packard, Casio, Compaq, Toshiba and others. Despite the large number of manufacturers producing pen-based handheld computers and the resulting variety of designs employed by each, all pen-based handheld computers generally include a small relatively flat generally rectangular housing within which a miniaturized computer circuit and memory is housed. A plurality of interactive buttons are usually supported upon the front surface of the housing and a typically rectangular interactive touch screen display is also provided. Additional circuitry within the housing allows the computer processor to interact with and manage the forming of display images upon the display screen and the reading of information applied via screen touching. A so-called pen which is actually a stylus is typically secured or received within a convenient holding position on or within the unit housing. The pen is generally elongated, usually cylindrical, and defines a relatively blunt point for screen touch action.

As low-cost microprocessor based computer and digital circuitry has become available in the market, such pen-based handheld computers have become increasingly popular and pervasive. Not surprisingly, a large number of system improvements and advances have also been provided by various practitioners in the art to move the product capabilities and efficiencies of pen-based computer systems forward to enhance product appeal. For example, U.S. Pat. No. 6,493,464 issued to Hawkins et al. sets forth a MULTIPLE PEN STROKE CHARACTER SET AND HANDWRITING RECOGNITION SYSTEM WITH IMMEDIATE RESPONSE which is capable of interpreting a special predefined set of single stroke glyphs. Each input stroke is identified with one of three categories, (1) pre-character modifier strokes, (2) character or symbol strokes, or (3) post-character modifier strokes. Each character stroke is independently recognized by the system processor and utilized in performing the display interpretation recognition and implementation.

U.S. Pat. No. 6,396,481 issued to Challa et al. sets forth an APPARATUS AND METHOD FOR PORTABLE HANDWRITING CAPTURE which combines a capture device such as a PDA, Notebook Computer, Set Top Box, Smart Television or other type of smart appliance having an image capture capability and built-in wireless transceiver together with an ink capture device. Communication between the ink capture device and the image capture device is achieved with conventional wireless technology.

U.S. Pat. No. 6,476,831 issued to Wirth et al. sets forth a VISUAL SCROLLING FEEDBACK AND METHOD OF ACHIEVING THE SAME which provides real-time visual feedback to the user while scrolling in standard windowing environments. The visual scrolling technique makes use of a transient overlay which provides direct visual cues to the user about the new areas of the scrolled document that have been exposed to view by the scrolling action.

U.S. Pat. No. 6,407,749 issued to Duke sets forth a COMBINED SCROLL AND ZOOM METHOD AND APPARATUS for simultaneously scrolling and zooming graphic data in a display device in response to pointing device action by user. The system alternates between zooming in and zooming out at preset rates in response to successive user actuation of a unique button set on the pointing device. While the button set remains actuated, the pointing device acts to pan the viewpoint.

Despite substantial advances and improvements of current pen-based handheld computer systems, their use in activities such as writing, drawing or marking requires further improvement to maximize efficiency. Such systems facilitate writing, drawing or marking the display to form or alter an image by repeatedly sensing the position of the pen point upon the touch screen display to derive a sequential set of pen point touch position. Thereafter, the system displays the locus of the pen point locations as the pen moves and connects each successive pen position in sequence of application to provide an image which is the locus of pen movements in a process similar to a “follow-the-dots” action. As a result, the user sees an image being formed virtually immediately behind the moving pen point upon the screen in a manner which appears to be writing or marking upon the screen by the user and which is often referred to as “digital ink”.

Currently, when interfacing in a graphical environment, often referred to as a page, that is much larger than the display screen, a scrolling feature is often implemented. Scrolling allows a user to navigate within a larger page by displaying a smaller portion thereof at a time. Scrolling allows a user to move a page up, down, or across a display screen, with new information appearing on the screen as old information disappears. Usually if a page is “scrollable” user interface objects such as scrollbars are also implemented. If a page is vertically scrollable because the page is vertically bigger than the display screen, a vertically running scrollbar is used. If a page is horizontally scrollable because the page is horizontally bigger than the display screen, a horizontally running scrollbar is used. Within these scrollbars there are also image objects known as scrollcars. Users often times refer to these image objects or scrollcars within their respective scrollbars to get a feel or a rough estimate as to what section of a page is being displayed. Usually along with being scrollable an image is less comprehensive, since the user is able to see only portion of the page. Being less comprehensive means that the user sees less of the entire page. Conversely, being more comprehensive means that the display screen or display window is showing more of a bird's eye view with greater encompassment of a particular page. As a page becomes bigger than the display screen, the scrollability increases and as a result the comprehensiveness decreases. Additionally, making a page one-way scrollable provides better comprehensiveness than making the same page scrollable both horizontally and vertically for reasons that will be further discussed below. Furthermore, for a given display screen area or display window a page being made only vertically scrollable results in what is displayed being more comprehensive than the same page being made both vertically and horizontally scrollable. Continuing on, if that same page is made to not be scrollable in any direction within the screen, meaning that the whole page is made to “fit” within the display window, what is being displayed will be more comprehensive the page being made only vertically scrollable as discussed above.

Once characteristic of writing upon a pen-based computer system arises when the user writes on an image, often referred to as a page for example, in circumstances in which the total document or page is much larger than that which may be displayed upon the display screen. Thus, as the user attempts to write on the display screen there is a substantial amount of the total image which is not displayed on the screen. The user often spends substantial time manipulating scroll bars or scroll buttons in the manner described above to utilize more writing space within the page and accommodate the limitations of display image or writing area size. Because the process of using scroll bars or scroll buttons to move the writing portion of the image relative to the total page, practitioners in the art have endeavored to provide a feature generally referred to as “autoscrolling”. The intention of autoscrolling is to provide an anticipatory scrolling of the text as the user writes upon the portion of the image display which approaches the right hand border of the display. But for the autoscrolling feature, the user upon reaching the right hand edge of the image display must employ the above-described manual scrolling. The autoscrolling solution is accomplished by establishing a autoscroll zone upon the image such as a margin along the right hand edge of the display. As the user writes upon the image display and the writing pen is moved into the established margin or scrolling zone, the next pen-up movement by the writer initiates a predetermined time interval during which the written text remains as written. This time interval is intended to permit the writer to complete the written material in the event the written material includes multi-stroke objects such as the letters f, t, i, j, k, x etc. Such letters require that the writer upon completing the text portion desired, lift the pen from the writing surface and go back to the left hand portions of the written text to cross t's, dot i's, etc. and complete the multi stroke characters. Once the predetermined time interval has timed out, the autoscroll system then automatically moves the text as written, hopefully with the multi strokes in place, to the left a predetermined distance leaving the right most characters of the written text exposed near the left edge of the image display. The user then adjust to the new position of the scrolled text and continues writing.

While autoscrolling systems has described have provided some improvement over the art, they must of necessity include substantial time delays to facilitate the completion of multi stroke characters within the text before scrolling it to the left. This allotted time is logically determined on a “worst case” basis in which the interval contemplates a substantial number of multi stroke objects in the written text. In many instances however, the worst case is not presented and perhaps only one or two objects are multi stroke objects. In this event, one substantial disadvantage to the present autoscrolling systems arises in that the user must wait for the scrolling process to take place. This results in a substantial loss of time. This loss time may in turn interrupt the writers thinking process and become somewhat annoying and frustrating.

In addition, the presently provided autoscrolling systems with their displacement of the written material using a predetermined distance for displacement often cover the starting portions of the written text leaving only the last character or two exposed at the left margin of the display image.

There arises therefore a need in the art for an improved autoscrolling system which overcomes the shortcomings and limitations of the prior art autoscrolling.

### SUMMARY OF THE INVENTION

The present invention provides an improved autoscrolling system which overcomes the limitations and disadvantages of the prior art autoscroll system. The present invention system establishes a scroll region comprising a right hand margin on the display image of a predetermined size. The system in its simplest form maintains a selected point in the to-be-scrolled text such as the left-most point or the pen-down movement of the writing action as the writer initiates a word during text entry. Thereafter, as the writer continues to write and enter text, the system maintains the position of the initial pen-down movement for later use. Once the pen writes into the scroll region, the system awaits the next pen-up movement executed by the writer. With the initiation of a pen-up movement within the scroll region, the system then immediately initiates a scroll to the left which is variable and which places the selected point (ie. the original pen-down portion of the text) at or near the left edge of the image display. Thereafter, the scrolled text remains in its scrolled position. The writer then has unlimited time to complete the multi stroke objects within the text portion since the entire text from the selected point is visible due to the variable dimension scroll which the system provides. The writer then simply executes the various multi stroke actions to complete the text and continues writing upon the image display. The avoidance of the time delay utilized by prior art autoscrolling systems allows the user to work continuously and naturally at the writers desired pace without interruption of the thought process.

Variations of the present invention system are provided to accommodate the typical operative environment of the anticipated type of writer utilizing the host device. In one variation of the invention, utilized in accommodating an unintentional pen-up movement by the user within the scroll region, the system is operative to inhibit the scroll once the unintentional pen-up movement occurs. Alternatively, the present invention system is operative to inhibit the writing function in the event the scroll is allowed to take place. This latter compensation allows the user to complete the text material prior to the initiation of scrolling. A further variation of the present invention is found in its ability to accommodate the writer's inadvertent attempt to continue adding multiple strokes to a text portion subsequent to the autoscrolling action. In such case, the system simply moves the new ink to the current position within the scrolled text.

In accordance with the present invention, there is provided for use in a handheld pen-based computer system, an improved auto-scrolling system comprising: means for establishing a scroll region having a right hand margin on the display image; means for maintaining a selected point in to-be-scrolled text in which the left-most point or pen down movement of writing action; and means for implementing a variable scroll at the right margin to the selected point without a threshold time delay.

### BRIEF DESCRIPTION OF THE DRAWINGS

The present invention is shown in the various Figures attached hereto in which each element maintains the same reference numeral in the various views shown herein and in which:

FIGS. 1A and 1B set forth window diagrams of the coordinate system utilized in defining the positions of points upon the onscreen window and offscreen windows of the system;

FIGS. 1C and 1D set forth respective diagrams which illustrate the operation of the present invention autoscrolling system in which the scroll region is shown in shaded depiction;

FIGS. 2A through 2D set forth flow diagrams of the operation of the present invention autoscroll system in its simplest form;

FIGS. 3A through 3D set forth flow diagrams of the operation of the present invention system in the event the writer writes into the scroll region and back out of it and thereafter performs a pen-up movement;

FIGS. 4A through 4D set forth flow diagrams of the present invention system operation in which the scroll is inhibited on pen-up movements within the scroll region if the prior stroke performed a scroll;

FIGS. 5A through 5D set forth flow diagrams of the operation of the present invention system in which scroll is inhibited on pen-up movement in the scroll region if the prior stroke performed a scroll and the pen-down for the current stroke was within the scroll region;

FIGS. 6A through 6D set forth flow diagrams of the operation of the present invention system showing pen up and pen down actions;

FIGS. 7A through 7D set forth flow diagrams of the operation of the present invention system showing scrolling on a pen-up within the scroll region while using the smallest horizontal axis point (that is left most point) of the stroke; and

FIGS. 8A through 8D set forth flow diagrams of the operation of the present invention system in which an erroneous current stoke is shifted to the correct position following a scroll.

### DESCRIPTION OF THE PREFERRED EMBODIMENTS

By way of overview, the present invention system provides an autoscroll in which the scrolling operation is initiated without the expiration of a threshold time. Instead the present invention system executes the autoscroll immediately upon the pen-up event within an established scroll region. In conventional text writing in which the user writes from left to right, the scroll region is established by a margin of a predetermined size along the right edge of the image display. Thus, in its simplest form, the system is operative to note a selected point in the to-be-scrolled text such as the left-most point or the pen-down point established as the user writes upon the image display and which results in the initiation of a pen-up movement within the scroll region. In this simplest form of the invention, the system scrolls the text material to the left immediately without the need for timing a predetermined interval or threshold. The invention provides the novel feature of using a variable scroll, the dimension of which is determined by the position of the selected point (ie. left-most or pen-down movement) which the user initiated in writing the text being scrolled. The size of leftward scrolling is selected to position the pen-down movement or left-most portion of the text being scrolled slightly to the right of the left edge of the image display. As a result, the entire scrolled text portion which typically forms the last word written is maintained in full view allowing the writer to complete all multiple strokes upon the text before continuing to write.

Variations of the present invention provide for addressing the variety of circumstances which the writer may create in using the pen based computer system. Thus, the system in certain environments accommodates an inadvertent pen-up movement by either inhibiting the scrolling action or alternatively inhibiting the write function when the pen in returned to the image display surface. The manner in which the system determines that an erroneous or unintentional pen-up move has been initiated may be carried forward by determining whether the writer initiated a pen-down move within the scroll region following the pen-up movement within the scroll region. The system in this embodiment determines that the initiation of a pen-up followed by a pen-down movement within the scroll region is unintentional. The system thus may react by either inhibiting the scroll function or inhibiting the writing function. Alternatively, the system may be configured any new writing by the user to the correct position in the event the text already has been allowed to scroll.

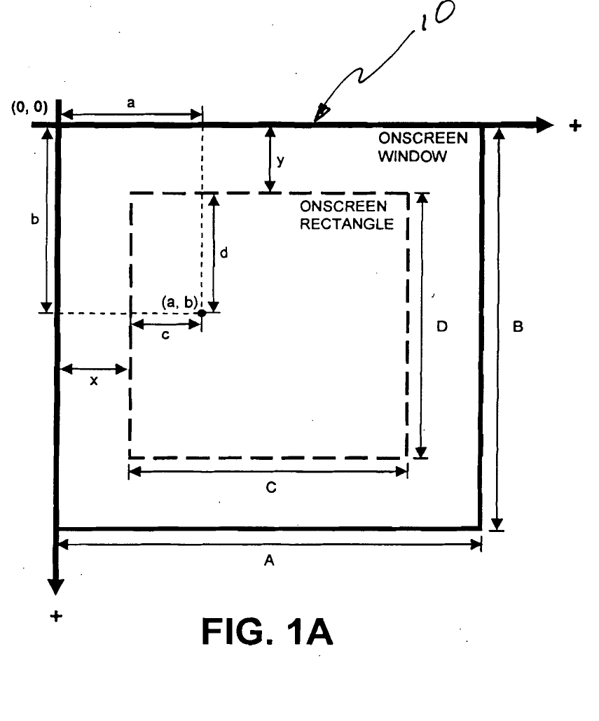

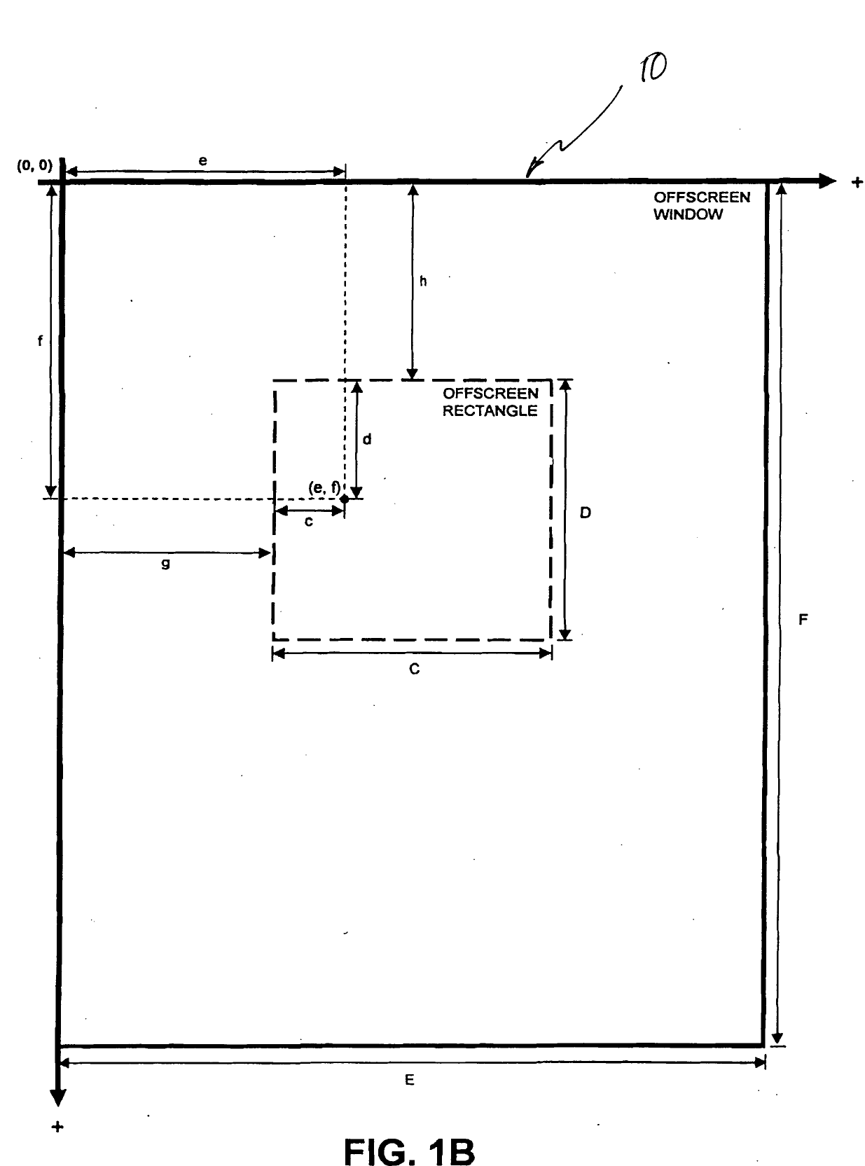

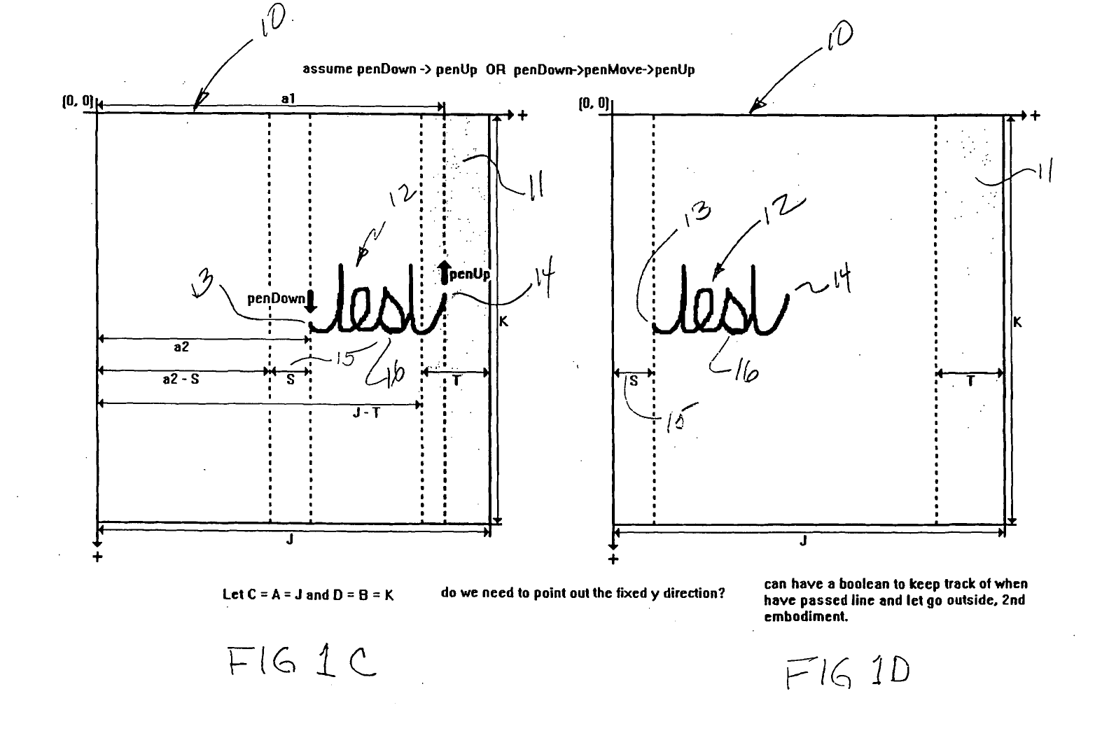

With simultaneous reference to FIGS. 1A through 1D, the present invention system establishes each point upon the image display using the coordinate system set forth in FIGS. 1A and 1B. FIGS. 1C and 1D illustrate the operation of the present invention system in its simplest form of autoscroll. Thus, in FIG. 1C, an image display 10 is divided by the present invention system to define a scroll region 11. Upon image display 10, a text word 12 has been written by the user in a typical writing sequence. This sequence provided a pen-down point 13, a text written portion 16 and a pen-up point 14. In other words, the user placed the writing stylus upon the image display at point 13 in a pen-down movement and thereafter wrote text 16 until raising the pen at pen-up point 14. The resulting combination of pen-down point 13, written text 16 and pen-up 14 comprises a word generally referenced by numeral 12. It will be noted that word 12 may be a word in the formal sense, or simply a segment of text formed by a succession of characters. It will be noted that the user has written the word “test”. And must now cross the first and last t characters in a multi stroke activity.

In accordance with the present invention and as is shown in FIG. 1D, the initiation of pen-up movement at point 14 within scroll region 11 causes the present invention system to displace word 12 to the left until pen-down point 13 is spaced from the left margin of image display 10 by a predetermined distance 15. Thereafter, the present invention system maintains the position of word 12 as shown. Of importance with respect to the present invention, is the availability of the entirety of word 12 for the user to be able to cross the first and last t character within the word. This is in sharp contrast to prior art systems in which a scroll of a predetermined length is initiated regardless of the position of the pen-down point in the scrolled character sequence.

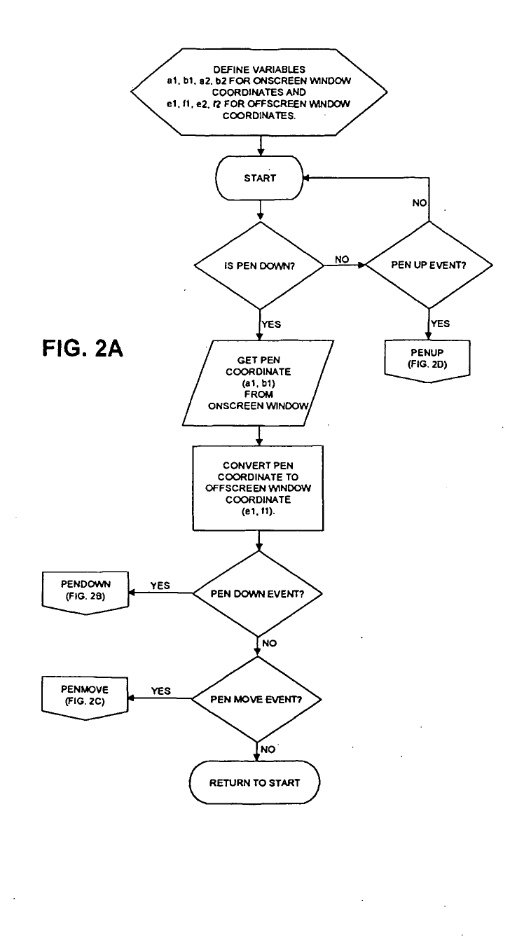

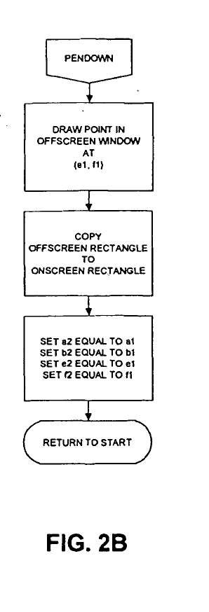

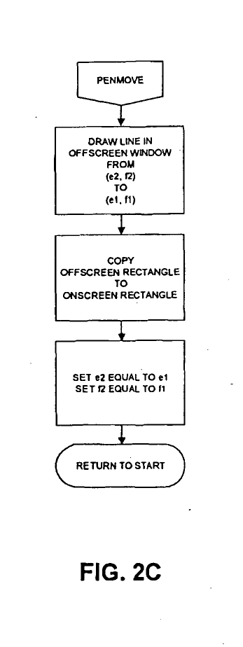

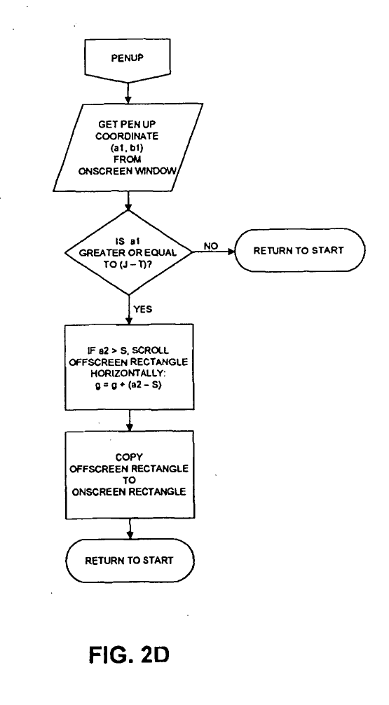

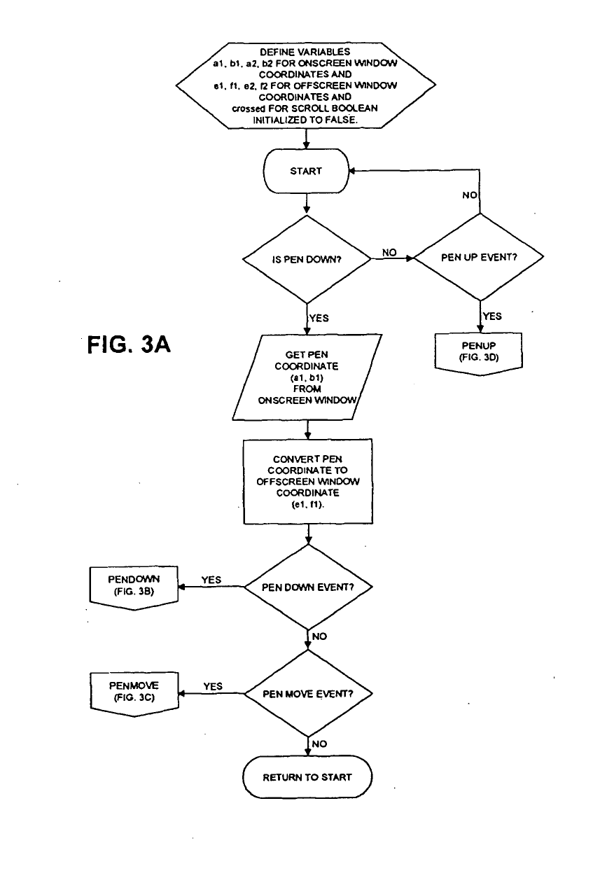

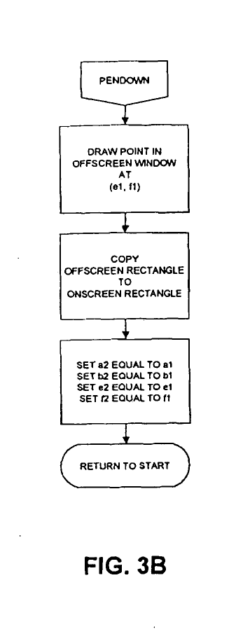

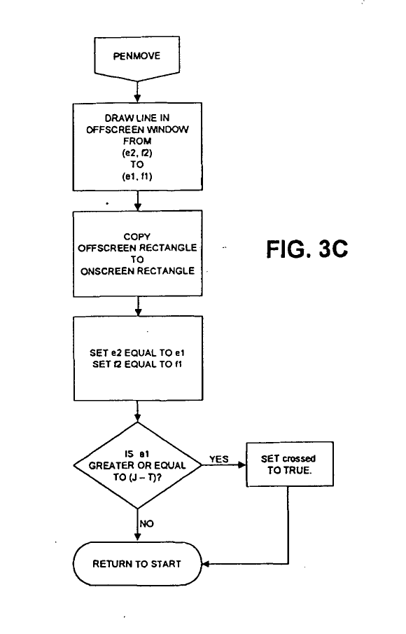

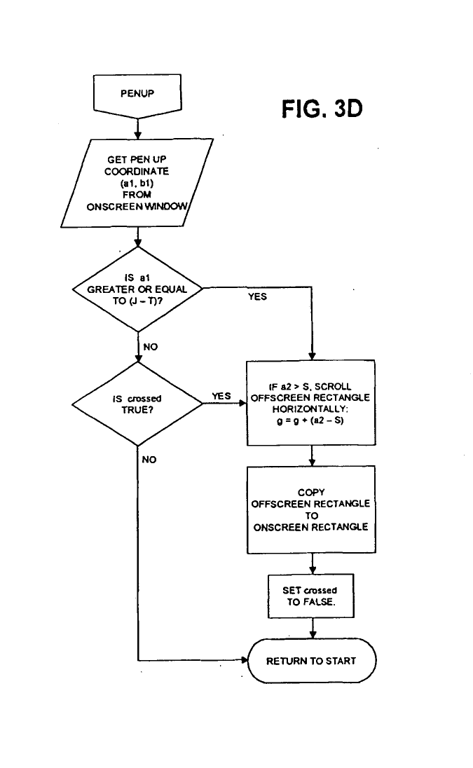

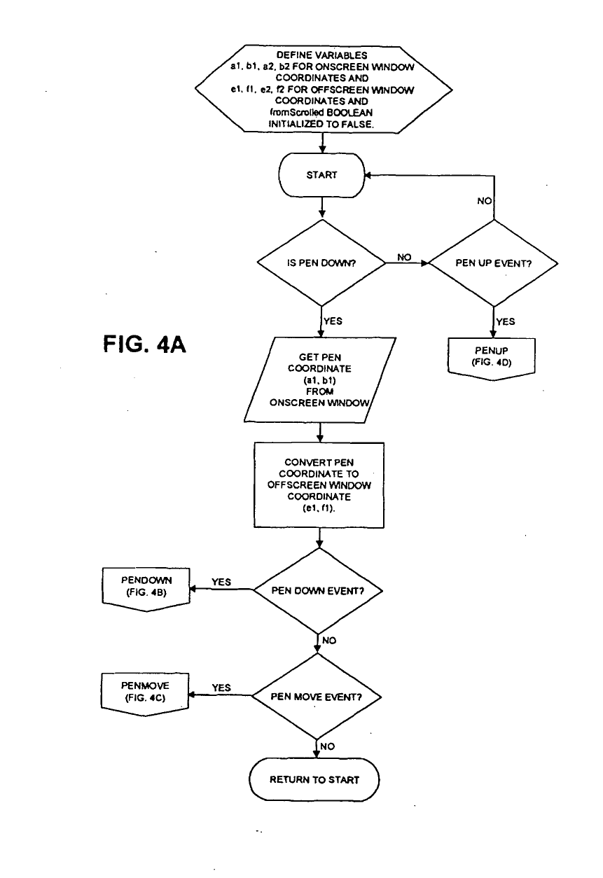

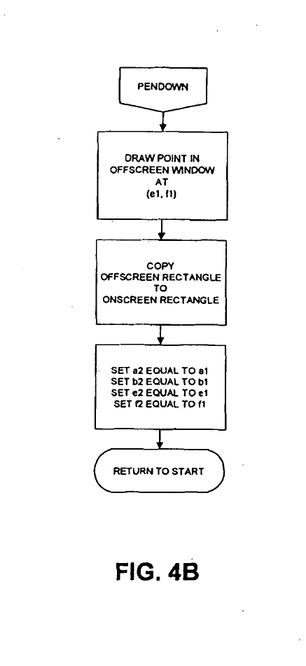

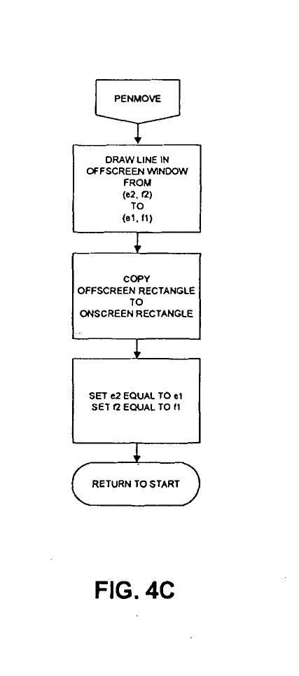

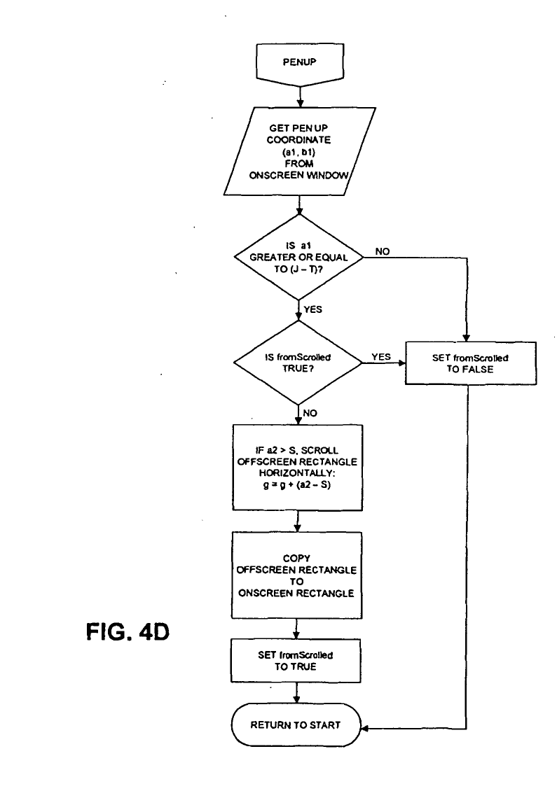

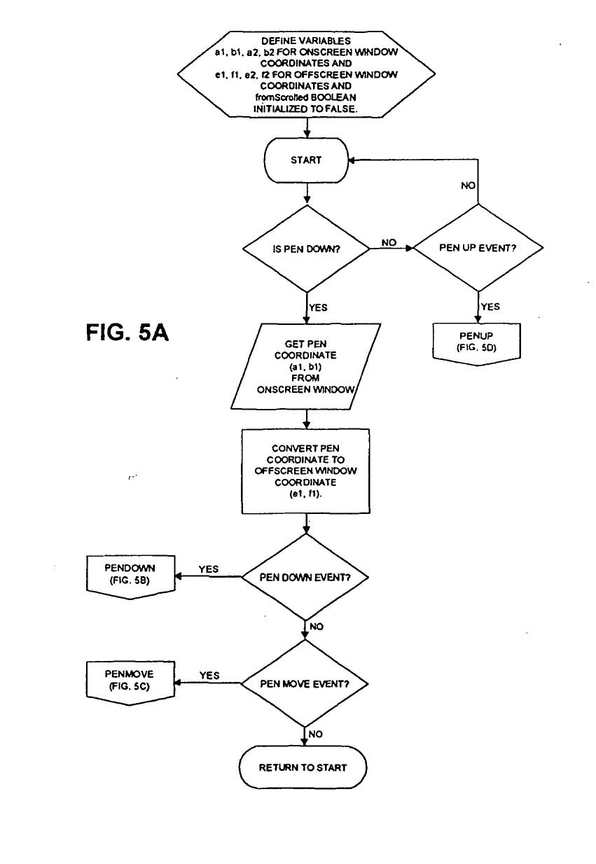

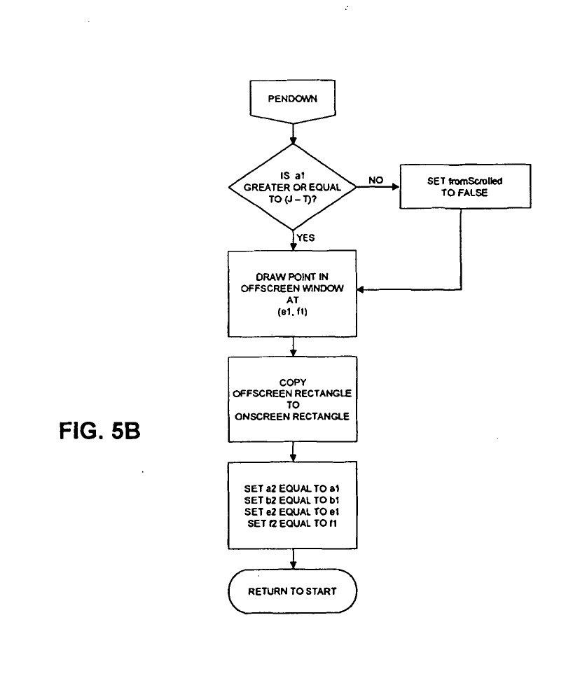

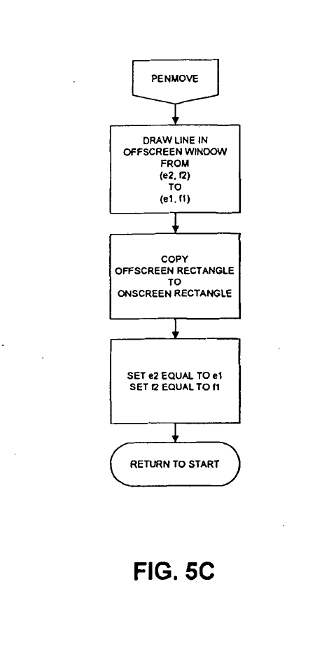

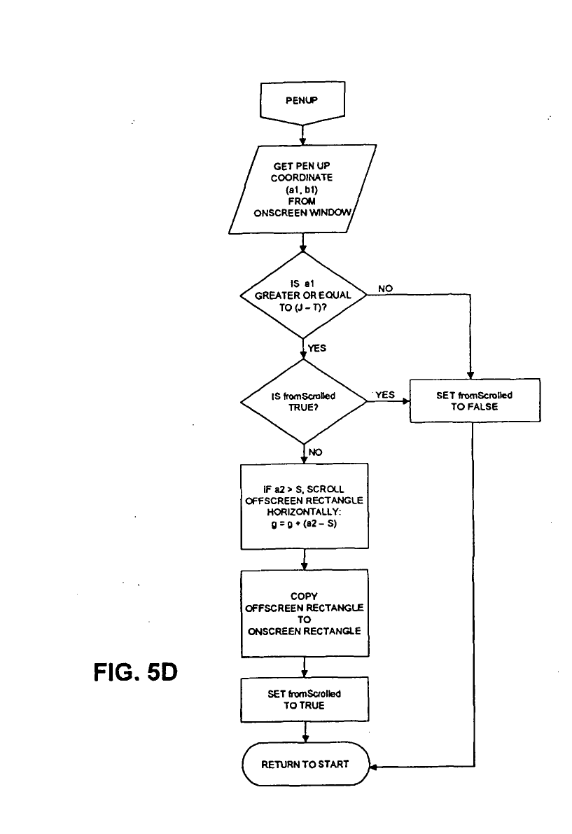

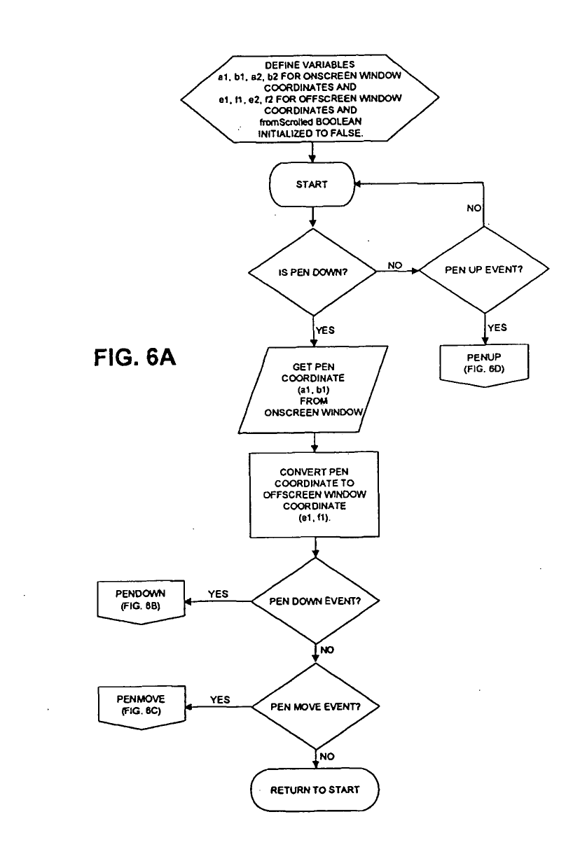

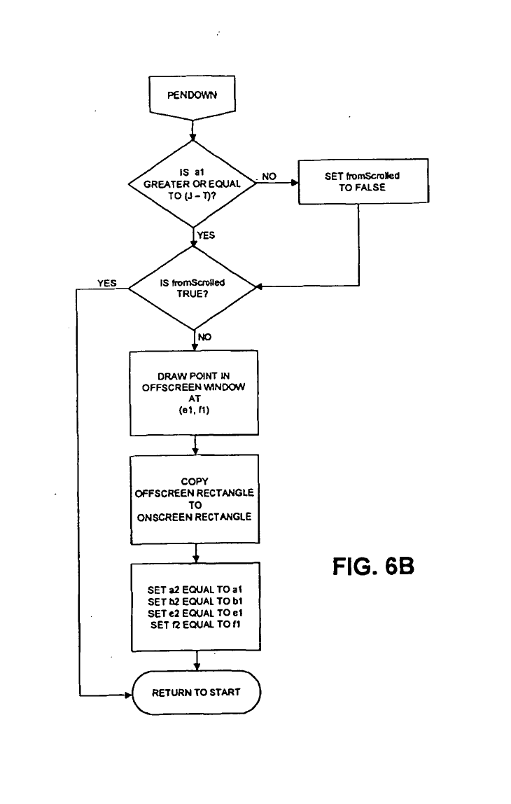

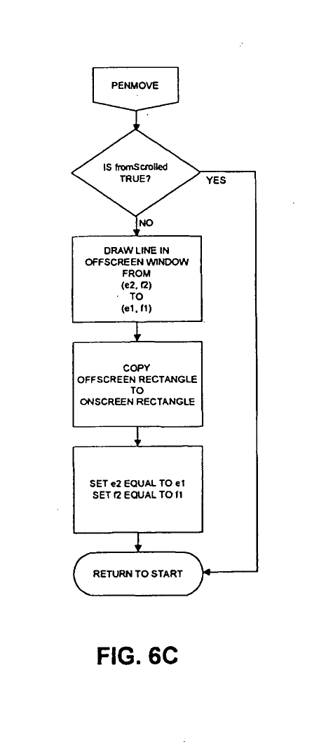

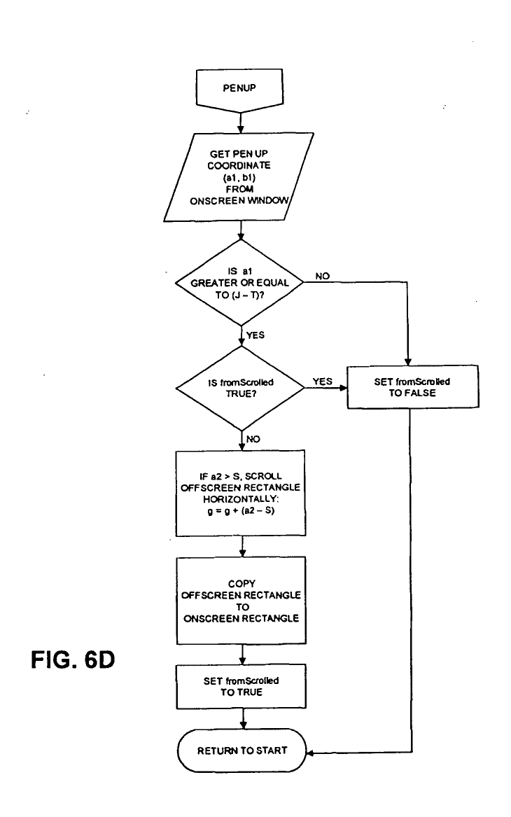

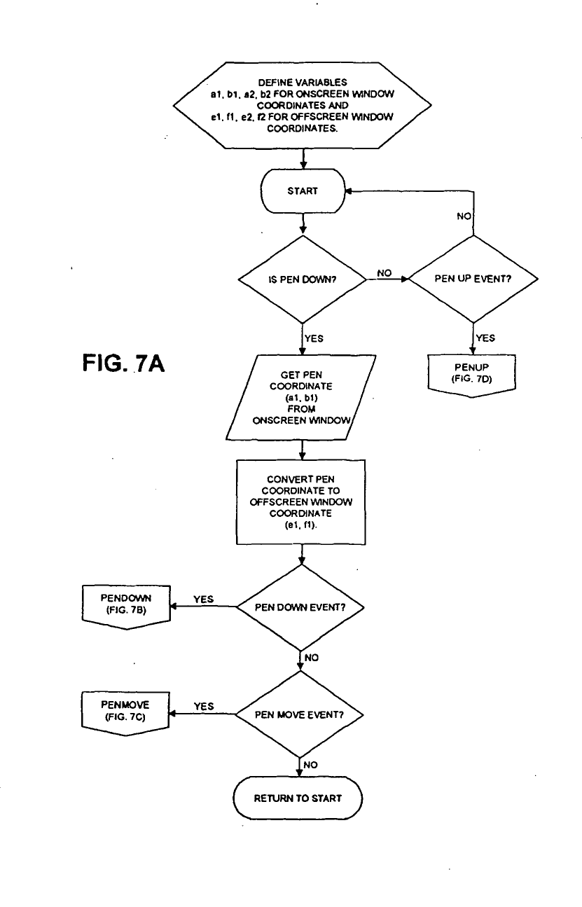

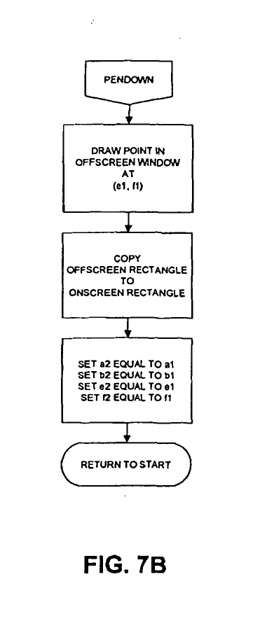

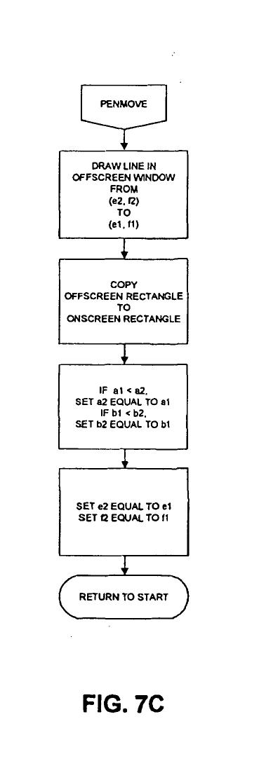

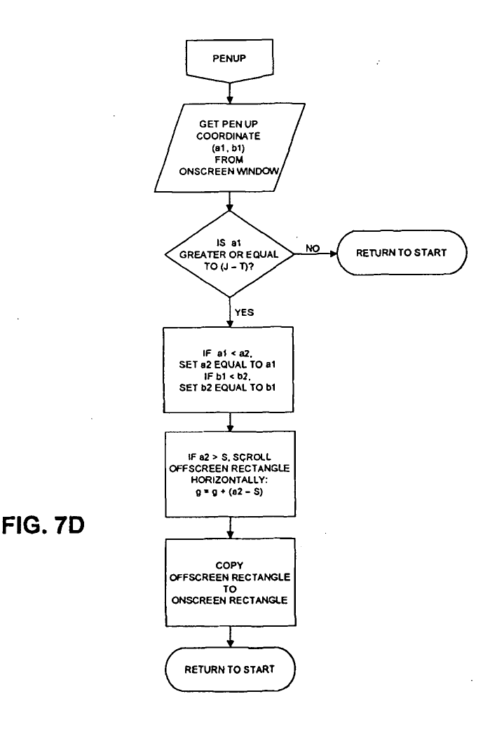

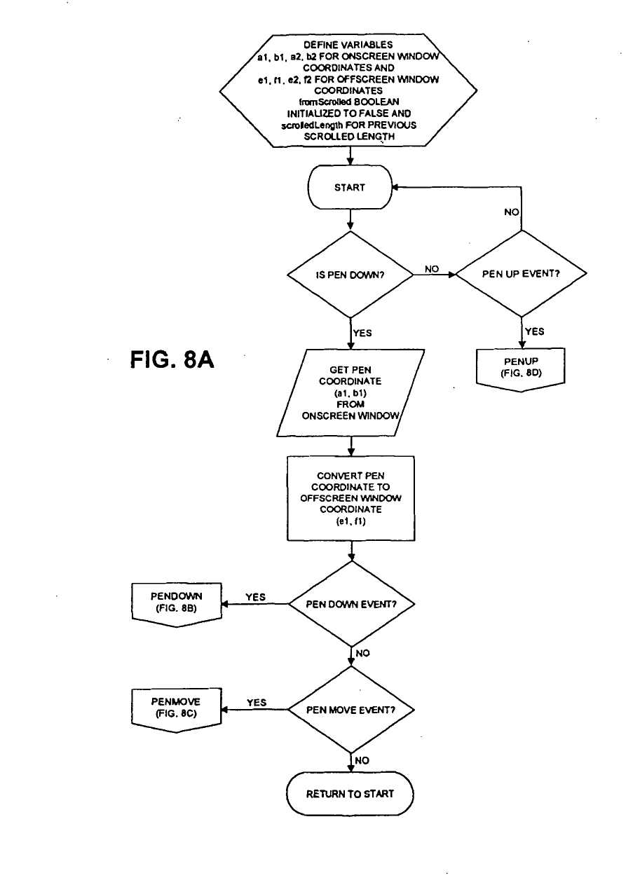

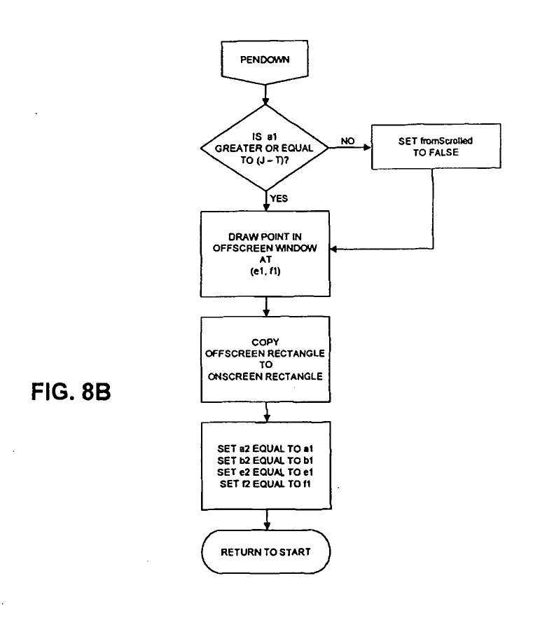

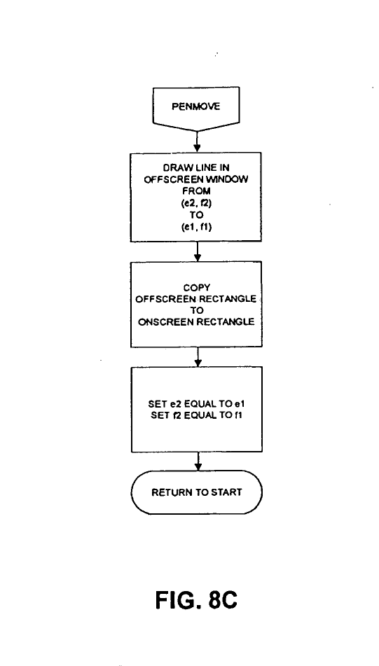

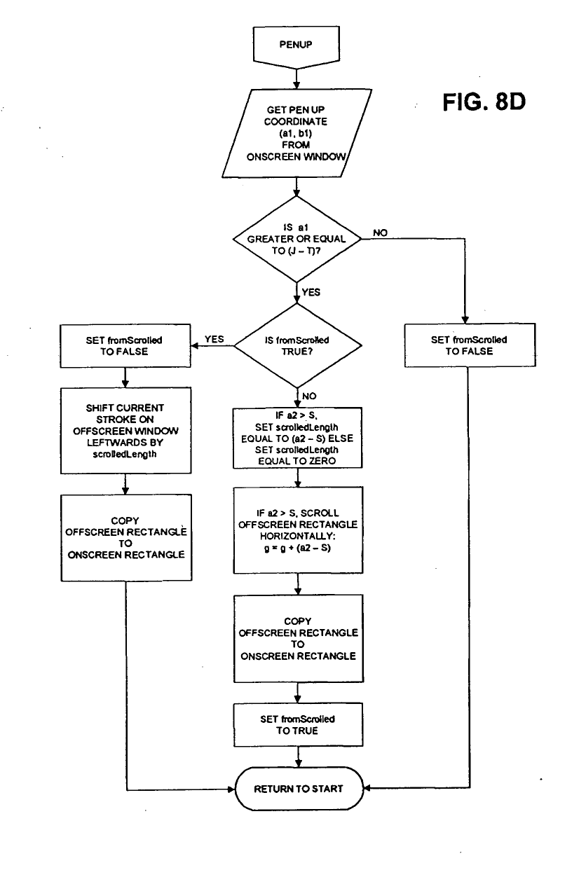

FIG. 2 through 8 set forth the flow diagrams of the operation of the present invention system in its various embodiments. In addition, the appendix attached hereto sets forth the software code of the present invention system corresponding to the flow diagrams shown in FIGS. 2 through 8.

Embodiments of the present invention include:

(1) penUp within the scroll region executes the scroll no matter if there was a penMove within the scroll region or not.

(2) penMove within the scroll region will execute the scroll on the penUp not matter if penUp is within or outside of scroll region.

(3) Variable horizontal scrolling based on the penDown point of the stroke that performs the scroll.

(4) Variable horizontal scrolling based on the furthest left point of the stroke that performs the scroll which might not be the penDown point.

(5) May be applied to horizontal or vertical scrolling. Should not limited to one direction scrolling and can be applied to any direction of scrolling (i.e. left to right, right to left, up to down, down to up, diagonal, etc.).

(6) Glyphs within scroll region performing a command (e.g. scroll, move, return to beginning of next line, etc.) instead of directly begin recorded to the page. In other words, there could be glyphs or marks that if made and understood by the program executes a command instead and will not perform a scroll even if the penUp point for that glyph was within the scroll region.

Further embodiments: When the user writes and does not adjust after the scroll, the user can run into the situation where the user writes where the user does not intend to write.

(A) If the method determines that the user intended to write the new ink to complete the scrolled multi stroke object but the position is incorrect (e.g. drawing an f, t, i, j, k, x, test, etc.):

(1) Do not scroll with the penUp for the next new ink or stroke and depending whether the user set a penDown within or outside of the scroll region for the new ink, do one of the following:

(a) leave the new ink intact

(b) erase the new ink or undo the new ink

(c) don't let the user write the ink to begin with, in other words, inhibit the ink mark

(d) move the new ink to the correct position

Main problem: When the user writes on an image (e.g. page) that is much smaller than what can be displayed on a display screen, there is a considerable amount of time spent manipulating scrollbars or scroll buttons to get to more writing space within the page. Over long use, this can really be frustrating to a user. Thus, the goal is to introduce a form of scrolling that will allow users to not hassle with scrollbars or scroll buttons and therefore be able to write with fewer interruptions.

Competitive Problem: Autoscrolling will not leave room in front to complete multi stroke objects. Solution: Intelligent variable scrolling, which is determined by penDown point of stroke that performs the scroll. Can also be determined by the smallest point of the stroke that performs the scroll.

Competitive Problem: Prior art uses time delays to perform autoscrolling however this would require an increasing amount of time to input information. The more completed objects you have the more time required waiting for the autoscroll there will be. More interruptions to the train of thought from the necessity to continuously write and wait and write and wait etc. Solution: Scroll at a penUp detection within a predetermined scroll region. Since this method does not use time delays or threshold time, users will have more control as to when the scrolling will take place. Therefore there is no additional waiting period except for the time it takes to scroll the image to get more writing space.

While particular embodiments of the invention have been shown and described, it will be obvious to those skilled in the art that changes and modifications may be made without departing from the invention in its broader aspects. Therefore, the aim in the appended claims is to cover all such changes and modifications as fall within the true spirit and scope of the invention.

That which is claimed is:

1. For use in a handheld pen-based computer system, an improved auto-scrolling system comprising:
means for establishing a scroll region having a right hand margin on the display image;
means for maintaining a selected point in to-be-scrolled text in which the left-most point or pen down movement of writing action; and
means for implementing a variable scroll at said right margin to said selected point without a threshold time delay.
